(19) United States
(12) Patent Application Publication
(10) Pub. No.: US 2015/0287145 A1
(43) Pub. Date: Oct. 8, 2015

(54) ASSESSING MERCHANT AFFINITY

(71) Applicant: MASTERCARD INTERNATIONAL INCORPORATED, Purchase, NY (US)

(72) Inventor: Edward M. Lee, Scarsdale, NY (US)

(73) Assignee: MASTERCARD INTERNATIONAL INCORPORATED, Purchase, NY (US)

(21) Appl. No.: 14/245,483

(22) Filed: Apr. 4, 2014

(51) Int. Cl. G06Q 40/00

(52) U.S. Cl. CPC G06Q 40/12

(57) ABSTRACT

There is provided a method that includes (a) accessing a database that contains records of payment card transactions, (b) filtering the records based on a filtering criterion and a period of time, thus yielding filtered transactions that occurred during the period of time, (c) identifying from the filtered transactions, customers of a first merchant, (d) identifying from the filtered transactions, a second merchant with which the customers engaged in transactions, and (e) calculating, from the filtered transactions, an index that indicates an affinity between the first merchant and the second merchant. There is also provided a system that employs the method, and a storage device that contains instructions for controlling a processor to perform the method.

### BACKGROUND OF THE DISCLOSURE

1. Field of the Disclosure

The present disclosure relates to analysis of payment card transactions. More particularly, the present disclosure relates to analysis of payment card transactions to discern an affinity between merchants, and facilitate relationships between the merchants.

2. Description of the Related Art

The approaches described in this section are approaches that could be pursued, but not necessarily approaches that have been previously conceived or pursued. Therefore, the approaches described in this section may not be prior art to the claims in this application and are not admitted to be prior art by inclusion in this section.

Due to increased amounts of data being generated, stored, and processed today, operational databases are constructed, categorized, and formatted for operational efficiency (e.g., throughput, processing speed, and storage capacity). Raw data found in these operational databases often exist as rows and columns of numbers and code that appear bewildering and incomprehensible to humans. Furthermore, the scope and vastness of the raw data stored in modern databases render it difficult for a person to locate usable information. Hence, analytic applications have been developed in an effort to help interpret, analyze, and compile the data so that it may be more readily understood by a person. These applications map, sort, categorize, and summarize the raw data before it is presented for display, so that individuals can interpret the data.

Data concerning payment card transactions, e.g., credit card and debit card transactions, is typically stored in a database, and in practice, given the prevalence of such cards and usage thereof, the quantity of transaction data is vast. For a person attempting to make sense of this vast amount of transaction data, there is no simple method for comparing and contrasting a subset of aggregated data as to a larger set of aggregated data.

### SUMMARY OF THE DISCLOSURE

The present disclosure provides a method that includes (a) accessing a database that contains records of payment card transactions, (b) filtering the records based on a filtering criterion and a period of time, thus yielding filtered transactions that occurred during the period of time, (c) identifying from the filtered transactions, customers of a first merchant, (d) identifying from the filtered transactions, a second merchant with which the customers engaged in transactions, and (e) calculating, from the filtered transactions, an index that shows an affinity between the first merchant and the second merchant.

The present disclosure also provides a system that employs the method, and a storage device that contains instructions for controlling a processor to perform the method.

### BRIEF DESCRIPTION OF THE DRAWINGS

FIG. 1 is a block diagram of a system for generating an affinity report.

FIGS. 2A-2C are, collectively, a block diagram of several interim storage structures employed in the system of FIG. 1.

FIGS. 3A-3C are, collectively, a flowchart of a process that is performed by the system of FIG. 1.

A component or a feature that is common to more than one drawing is indicated with the same reference number in each of the drawings.

### DESCRIPTION OF THE DISCLOSURE

An affinity report is a report that indicates, with regard to behavior of consumers, a degree of similarity between a subject merchant and another merchant.

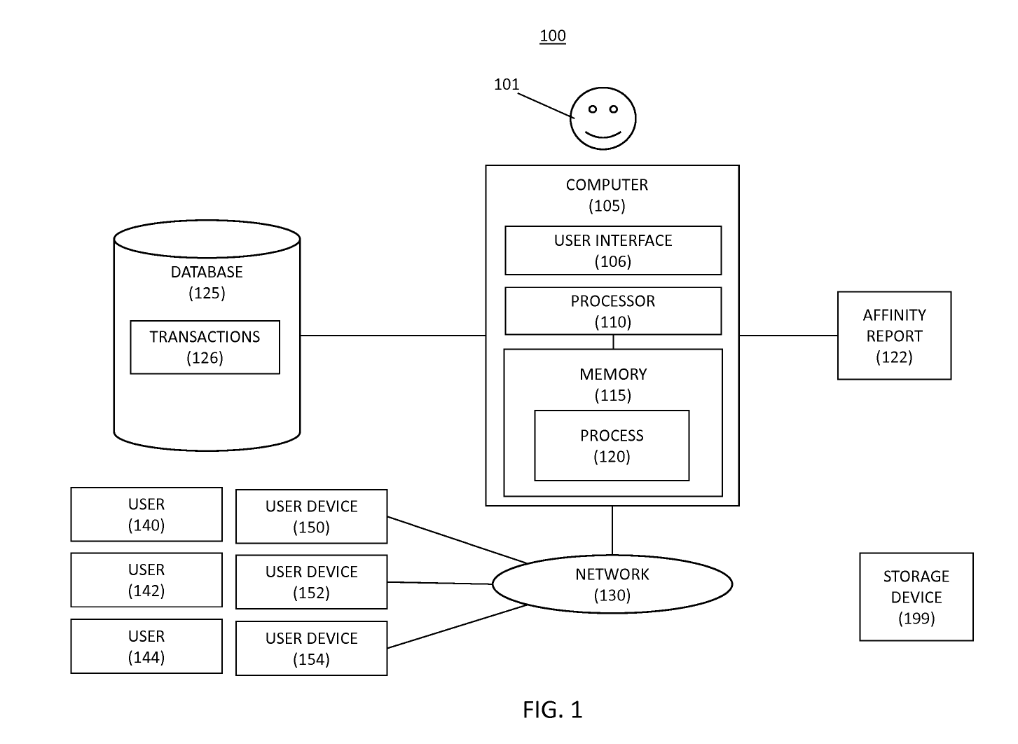

Referring to the drawings, FIG. 1 is a block diagram of a system 100 for generating an affinity report 122. System 100 includes a computer 105 coupled to a database 125 and a network 130.

System 100 also includes a user device 150, a user device 152, and a user device 154. User device 150 is operated by a user 140, user device 152 is operated by a user 142, and user device 154 is operated by a user 144. Each of user devices 150, 152 and 154 is communicatively coupled to computer 105 via network 130. Exemplary embodiments of user devices 150, 152 and 154 are a desktop computer, a portable computer, a tablet computer, a cell phone, and a smart phone.

Database 125 has transactions 126 stored therein. Transactions 126 are records of payment card transactions, i.e., credit card transactions and debit card transactions. For each such transaction, a corresponding record provides the following information:
(a) date of the transaction;
(b) card account number;
(c) merchant, i.e., identity of the merchant;
(d) card type; e.g., credit card or debit card;
(e) swipe location, e.g., address at which the card was swiped for the transaction; and
(f) amount of the transaction.

In brief, computer 105 analyzes transactions 126 to generate affinity report 122. For example, for a Merchant-X, affinity report 122 indicates, with regard to behavior of a population of consumers, a degree of similarity between Merchant-X and another merchant.

Network 130 is a data communications network. Network 130 can be a private network or a public network, and can include any or all of (a) a personal area network, e.g., covering a room, (b) a local area network, e.g., covering a building, (c) a campus area network, e.g., covering a campus, (d) a metropolitan area network, e.g., covering a city, (e) a wide area network, e.g., covering an area that links across metropolitan, regional, or national boundaries, or (f) the Internet. Network 130 can also include a cellular telephone network. Communications are conducted via network 130 by way of electronic signals and optical signals.

Computer 105 includes a user interface 106, a processor 110, and a memory 115 coupled to processor 110. Although computer 105 is represented herein as a standalone device, it is not limited to such, but instead can be coupled to other devices (not shown) in a distributed processing system.

User interface 106 includes an input device, such as a keyboard or speech recognition subsystem, for enabling a user 101 to communicate information and command selections to processor 110. User interface 106 also includes an output device such as a display, a printer, or a speech synthesizer. A cursor control such as a mouse, track-ball, or touch-sensitive screen, allows user 101 to manipulate a cursor on the display for communicating additional information and command selections to processor 110.

Processor 110 is an electronic device configured of logic circuitry that responds to and executes instructions.

Memory 115 is a tangible computer-readable storage device encoded with a computer program. In this regard, memory 115 stores data and instructions, i.e., program code, that are readable and executable by processor 110 for controlling the operation of processor 110. Memory 115 can be implemented in a random access memory, a hard drive, a read only memory, or a combination thereof. One component of memory 115 is a process 120.

Process 120 is a program module that contains instructions for controlling processor 110 to execute operations described herein. In the present document, when operations are described as being performed by computer 105 or process 120, the operations are actually being performed by processor 110.

The term “module” is used herein to denote a functional operation that can be embodied either as a stand-alone component or as an integrated configuration of a plurality of subordinate components. Thus, process 120 can be implemented as a single module or as a plurality of modules that operate in cooperation with one another. Moreover, although process 120 is described herein as being installed in memory 115, and therefore being implemented in software, it could be implemented in any of hardware (e.g., electronic circuitry), firmware, software, or a combination thereof.

Processor 110 generates affinity report 122 as a result of an execution of process 120. In this regard, processor 110 could direct affinity report 122, or additional information derived therefrom, to user interface 106, or a storage device (not shown), any of user device 150, 152 or 154, or another remote device (not shown) via network 130.

While process 120 is indicated as already loaded into memory 115, it can be configured on a storage device 199 for subsequent loading into memory 115. Storage device 199 is a tangible computer-readable device that stores process 120 thereon. Examples of storage device 199 include a compact disk, a magnetic tape, a read only memory, an optical storage media, a hard drive or a memory unit having multiple parallel hard drives, and a universal serial bus (USB) flash drive. Alternatively, storage device 199 can be a random access memory, or other type of electronic storage device, located on a remote storage system (not shown) and coupled to computer 105 via network 130.

Below, operations performed in accordance with process 120 are described by way of an example in which for a merchant designated as Merchant-X, having customers, processor 110 prepares affinity report 122, which indicates other merchants that are utilized by those customers.

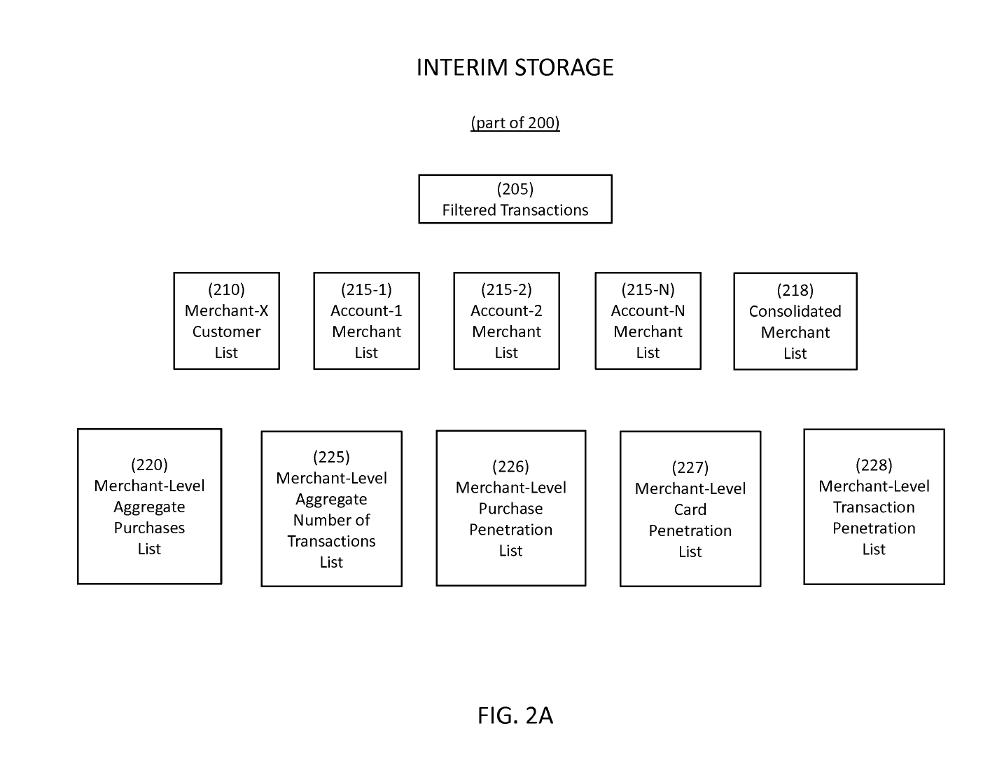

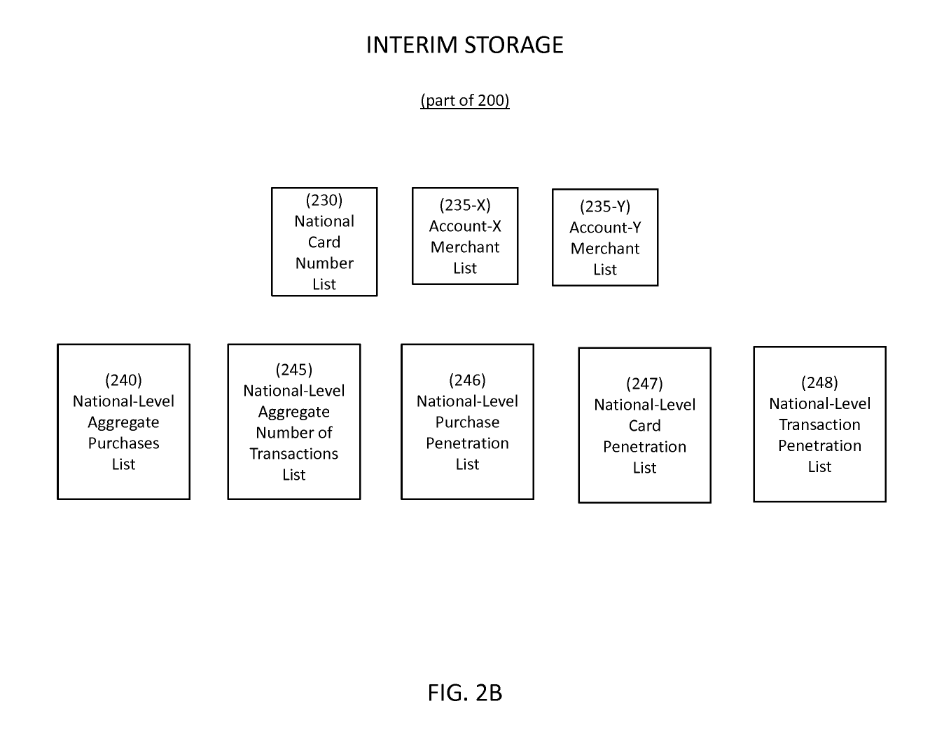

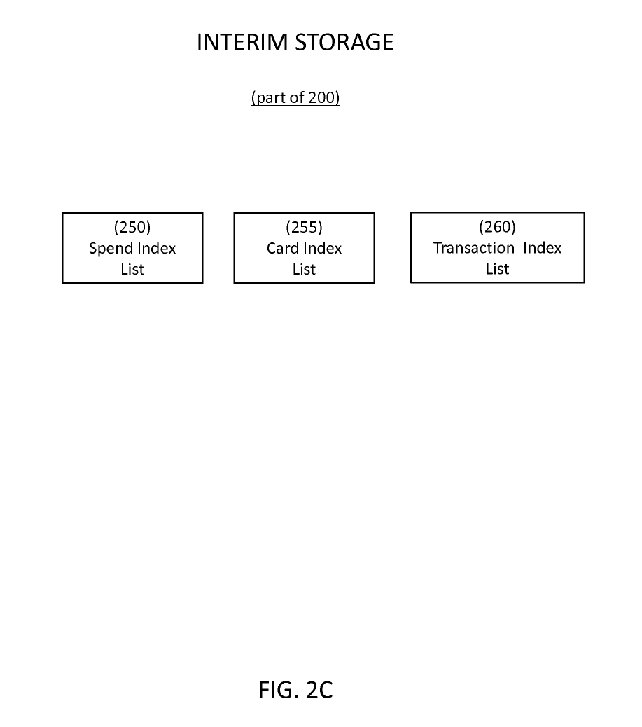

FIGS. 2A-2C are, collectively, a block diagram of several interim storage structures, i.e., structures 200, that are utilized by processor 110 during the execution of process 120. Structures 200 include:
(a) Filtered transactions 205;
(b) Merchant-X customer list 210;
(c) Account-1 merchant list 215-1;
(d) Account-2 merchant list 215-2;
(e) Account-N merchant list 215-N;
(f) Consolidated merchant list 218;
(g) Merchant-level aggregate purchases list 220;
(h) Merchant-level aggregate number of transactions list 225;
(i) Merchant-level purchase penetration list 226;
(j) Merchant-level card penetration list 227;
(k) Merchant-level transaction penetration list 228;
(l) National card number list 230;
(m) Account-X merchant list 235-X;
(n) Account-Y merchant list 235-Y;
(o) National-level aggregate purchases list 240;
(p) National-level aggregate number of transactions list 245;
(q) National-level purchase penetration list 246;
(r) National-level card penetration list 247;
(s) National-level transaction penetration list 248;
(t) Spend index list 250;
(u) Card index list 255; and
(v) Transaction index list 260.

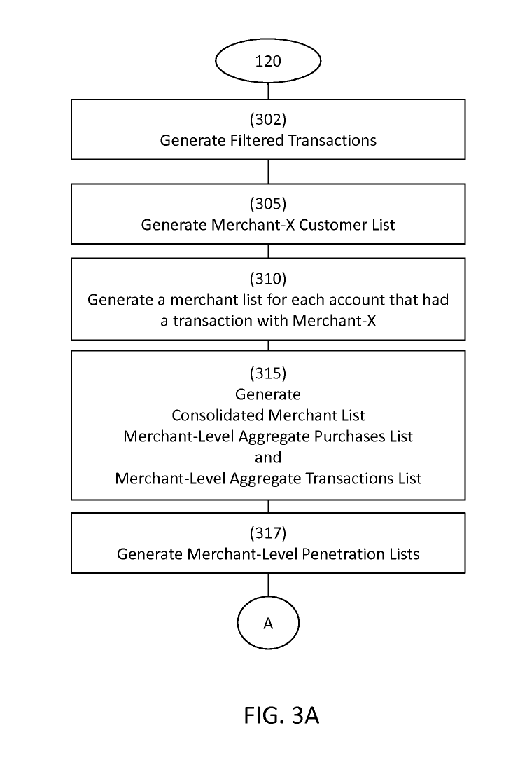

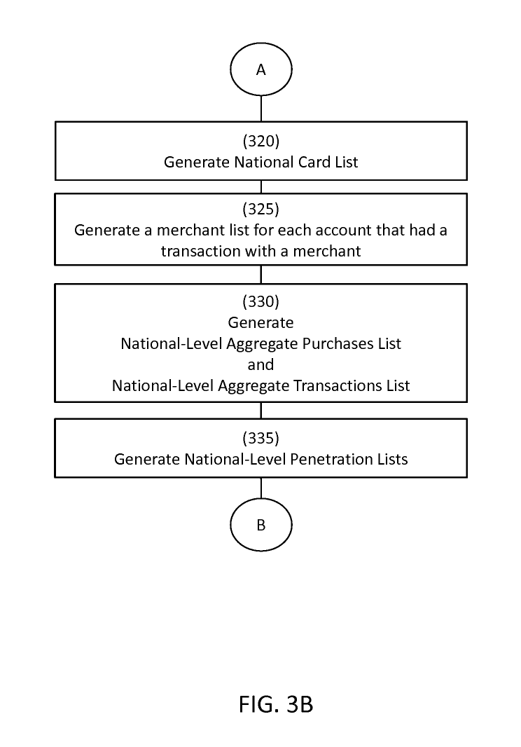

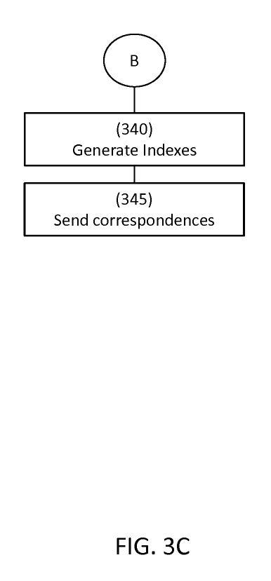

FIGS. 3A-3C are, collectively, a flowchart of process 120. FIGS. 3A and 3B are connected to one another by way of a connecting bubble “A”, and FIGS. 3B and 3C are connected to one another by way of a connecting bubble “B”. As mentioned above, operations performed in accordance with process 120 are described by way of an example in which for a merchant designated as Merchant-X, processor 110 prepares affinity report 122. Process 120 commences with step 302.

In step 302, computer 105 receives a communication that invokes process 120. In the present example, process 120 is invoked in response to a communication, e.g., a request, from user 101 that specifies a subject merchant and a period of time. However, process 120 could be invoked in response to a similar communication from any of user device 150, user device 152 or user device 154. The communication for invoking process 120 could also specify filtering criteria, which is further discussed below.

Below, we are presenting an example where:
(a) subject merchant=Merchant-X; and
(b) specified period of time=Jan. 1, 2013 through Dec. 31, 2013.

Transactions 126, as mentioned above, are records of payment card transactions, e.g., credit card and debit card transactions.

In step 302, processor 110 accesses transactions 126 to filter, and accept for further processing, a particular subset of transactions 126, thus yielding filtered transactions 205. Processor 110 can accept or reject transactions 126 based on any, all or none of the following criteria:
(a) consumer card product;
(b) corporate card product;
(c) credit card;
(d) debit card;
(e) date/time of transaction;
(f) geographic location of transaction;
(g) bank of issuance of card;
(h) card tier (e.g., premium service, rewards, miles, etc.);
(i) affiliation of card (i.e., a card affiliated with a particular commercial entity).

Table 1 shows several examples of combinations of criteria that can be used to categorize transactions.

TABLE 1
Exemplary combinations of criteria for categorizing transactions

| Card Type | Product | Credit/ | | Bank of |
|---|---|---|---|---|
| Lookup | Type | Debit | Product Name | Issuance |
| A | Consumer | Credit | Merchant-1 Card | Bank 1 |
| B | Consumer | Credit | Merchant-2 Card | Bank 2 |
| C | Consumer | Credit | Cash Rewards | Bank 1 |
| D | Corporate | Credit | Miles back | Bank 1 |
| E | Consumer | Debit | Cash Rewards | Bank 2 |

For example, as shown in Table 1, a card type “A” designates a card as being a consumer product type, credit card, affiliated with Merchant-1, and issued by Bank 1.

If, for execution of process 120, we only wanted to compare Consumer Credit Cards (i.e., Product Type=Consumer; and Credit/Debit=Credit) in our universe of study, then we would retain transactions for card types A, B and C.

If we want our universe to be only cards issued by Bank 1, then we would retain transactions for card types of A, C and D.

Table 2 is an example of transactions 126, i.e., before the filtering operation of step 302. Table 2 is abbreviated, and as such, does not necessarily contain all entries for the example presented herein.

TABLE 2
Transactions 126

| Date/Time | Credit card | | | | |
|---|---|---|---|---|---|
| of | account | | Card | Swipe | |
| transaction | number | Merchant | Type | Location | Amount |
| Dec. 31, 2012 | Account-1 | Merchant-1 | A | New York | 10 |
| Jan. 1, 2013 | Account-1 | Merchant-X | A | New York | 2 |
| Jan. 2, 2013 | Account-2 | Merchant-X | B | New | 3 |
| | | | | Jersey | |
| May 3, 2013 | Account-N | Merchant-X | C | Brazil | 1 |
| May 31, 2013 | Account-1 | Merchant-1 | A | New York | 4 |
| Jul. 1, 2013 | Account-1 | Merchant-1 | B | New York | 6 |
| Aug. 13, 2013 | Account-N | Merchant-1 | B | Brazil | 30 |
| Sep. 23, 2013 | Account-N | Merchant-1 | D | Brazil | 15 |
| Dec. 31, 2013 | Account-N | Merchant-1 | E | Brazil | 25 |

For example, as shown in Table 2, on 12/31/12 (i.e., Dec. 31, 2012), Account-1 engaged in a transaction with Merchant-1, using a card of type “A” (see Table 1), in New York, for an amount of $10.

For the sake of brevity, in Table 2, the Date/Time of transaction is abbreviated to show only the date. In Table 2 the swipe location merely indicates a US state or a country, but in practice, could more specifically indicate an address at which the card was swiped. Also, in practice, transactions 126 will likely include records for millions of transactions, instead of only a few transactions as shown in Table 2.

Table 3 shows an example of filtered transactions 205 for a case, with reference to both of Tables 1 and 2, where we wish for our universe to be only US transactions that occurred between the dates of Jan. 1, 2013 through Dec. 31, 2013. Table 3 is abbreviated, and as such, does not necessarily contain all entries for the example presented herein.

TABLE 3
Example of filtered transactions 205

| Date/Time | Credit card | | | | |
|---|---|---|---|---|---|
| of | account | | Card | Swipe | |
| transaction | number | Merchant | Type | Location | Amount |
| Jan. 1, 2013 | Account-1 | Merchant-X | A | New York | 2 |
| Jan. 2, 2013 | Account-2 | Merchant-X | B | New | 3 |
| | | | | Jersey | |
| May 31, 2013 | Account-1 | Merchant-1 | A | New York | 4 |
| Jul. 1, 2013 | Account-1 | Merchant-1 | B | New York | 6 |

From step 302, process 120 progresses to step 305.

In step 305, processor 110 accesses filtered transactions 205, and obtains records for Merchant-X, i.e., the subject merchant, having dates that fall within the specified period of time, i.e., Jan. 1, 2013 through Dec. 31, 2013, and generates Merchant-X customer list 210.

Merchant-X customer list 210 is a list of account numbers of credit cards of customers that made at least some threshold number of purchases, e.g., greater than or equal to 1, with Merchant X. Merchant-X customer list 210 does not necessary list every transaction conducted between the customer and Merchant-X, but instead, lists the customer if the customer made at least the threshold number of purchases. For example, if a customer used a particular credit card to make five purchases with Merchant-X, Merchant-X customer list 210 would have one entry for the account number of that credit card. Although in practice, Merchant-X customer list 210 would likely list a large number of accounts, for purpose of example, assume that Merchant-X customer list 210 lists three accounts, namely, Account-1, Account-2 and Account-N.

Table 4 is an example of Merchant-X customer list 210.

TABLE 4
Merchant-X customer list 210
Account Number

Account-1
Account-2
Account-N

From step 305, process 120 progresses to step 310.

In step 310, processor 110 accesses filtered transactions 205 and generates, for each account listed in Merchant-X customer list 210, a list of merchants, other than Merchant-X, from which the account made at least some threshold number of purchases, e.g., greater than or equal to one purchase, during the specified period of time, i.e., Jan. 1, 2013 through Dec. 31, 2013.

For example, since Merchant-X customer list 210 lists Account-1, Account-2 and Account-N, processor 110 will construct:
(a) Account-1 merchant list 215-1, which lists merchants from which Account-1 made at least one purchase;
(b) Account-2 merchant list 215-2, which lists merchants from which Account-2 made at least one purchase; and
(c) Account-N merchant list 215-N, which lists merchants from which Account-N made at least one purchase.

Each of Account-1 merchant list 215-1, Account-2 merchant list 215-2, and Account-N merchant list 215-N, also includes a number of transactions at each merchant, and an aggregate amount of the purchases at each merchant.

Table 5 is an example of Account-1 merchant list 215-1.

TABLE 5
Account-1 merchant list 215-1

| Merchant | Number of transactions | Amount ($) |
|---|---|---|
| Merchant-X | 1 | 30 |
| Merchant-1 | 1 | 10 |
| Merchant-2 | 2 | 20 |
| Merchant-3 | 4 | 30 |

Account-1 merchant list 215-1, as exemplified in Table 5, shows that Account-1, during the period of time from Jan. 1, 2013 through Dec. 31, 2013, spent $30 with Merchant-X, $10 with Merchant-1, $20 with Merchant-2, and $30 with Merchant-3.

Table 6 is an example of Account-2 merchant list 215-2.

TABLE 6
Account-2 merchant list 215-2

| Merchant | Number of transactions | Amount ($) |
|---|---|---|
| Merchant-X | 2 | 40 |
| Merchant-2 | 3 | 15 |
| Merchant-3 | 3 | 25 |
| Merchant-4 | 1 | 35 |

Account-2 merchant list 215-2, as exemplified in Table 6, shows that Account-2, during the period of time from Jan. 1, 2013 through Dec. 31, 2013, spent $40 with Merchant-X, $15 with Merchant-2, $25 with Merchant-3, and $35 with Merchant-4.

Table 7 is an example of Account-N merchant list 215-N.

TABLE 7
Account-N merchant list 215-N

| Merchant | Number of transactions | Amount ($) |
|---|---|---|
| Merchant-X | 3 | 30 |
| Merchant-1 | 1 | 60 |
| Merchant-3 | 2 | 40 |
| Merchant-5 | 1 | 20 |

Account-N merchant list 215-N, as exemplified in Table 7, shows that Account-N, during the period of time from Jan. 1, 2013 through Dec. 31, 2013, spent $30 with Merchant-X, $60 with Merchant-1, $40 with Merchant-3, and $20 with Merchant-5.

From step 310, process 120 progresses to step 315.

In step 315, processor 110 generates Consolidated merchant list 218, Merchant-level aggregate purchases list 220 and Merchant-level aggregate number of transactions list 225.

Consolidated merchant list 218 lists all of the merchants with which customers of Merchant-X have engaged in transactions during the specified period of time. In the present example, Consolidated merchant list 218 is a list of all merchants that are listed in Account-1 merchant list 215-1, Account-2 merchant list 215-2, and Account-N merchant list 215-N.

Table 8 is an example of Consolidated merchant list 218.

TABLE 8
Consolidated merchant list 218
Merchant

Merchant-X
Merchant-1
Merchant-2
Merchant-3
Merchant-4
Merchant-5

Merchant-level aggregate purchases list 220 lists, for each of Merchant-X and the other merchants with which customers of Merchant-X had transactions during the specified period of time, the aggregate value of the transactions for each of Merchant-X and the other merchants and for each customer.

Table 9 is an example of Merchant-level aggregate purchases list 220.

TABLE 9
Merchant-level aggregate purchases list 220

| Merchant | Account-1 | Account-2 | Account-N | Total ($) |
|---|---|---|---|---|
| Merchant-X | 30 | 40 | 30 | 100 |
| Merchant-1 | 10 | 0 | 60 | 70 |
| Merchant-2 | 20 | 15 | 0 | 35 |
| Merchant-3 | 30 | 25 | 40 | 95 |
| Merchant-4 | 0 | 35 | 0 | 35 |
| Merchant-5 | 0 | 0 | 20 | 20 |
| Total | 90 | 115 | 150 | 355 |

For example, each of Account-1, Account-2 and Account-N corresponds to a respective customer of Merchant-X. Accordingly, Table 9 shows that during the period of time from Jan. 1, 2013 through Dec. 31, 2013, (a) Account-1, Account-2 and Account-N, in aggregate, spent $100 with Merchant-X, and (b) Account-1 spent $90, in aggregate, with all of the merchants.

Merchant-level aggregate transactions list 225 lists, for each of Merchant-X and the other merchants with which customers of Merchant-X had transactions during the specified period of time, the aggregate number of transactions for each of Merchant-X and the other merchants, and for each customer.

Table 10 is an example of Merchant-level aggregate number of transactions list 225.

TABLE 10
Merchant-level aggregate number of transactions list 225

| Merchant | Account-1 | Account-2 | Account-N | Total Trans |
|---|---|---|---|---|
| Merchant-X | 1 | 2 | 3 | 6 |
| Merchant-1 | 1 | 0 | 1 | 2 |
| Merchant-2 | 2 | 3 | 0 | 5 |
| Merchant-3 | 4 | 3 | 2 | 9 |
| Merchant-4 | 0 | 1 | 0 | 1 |
| Merchant-5 | 0 | 0 | 1 | 1 |
| Total | 8 | 9 | 7 | 24 |

Table 10 states, for example, that during the period of time from Jan. 1, 2013 through Dec. 31, 2013, (a) Account-1, Account-2 and Account-N, in aggregate, engaged in 6 transactions with Merchant-X, and (b) Account-1 engaged in 8 transactions, in aggregate, with all of the merchants.

From step 315, process 120 progresses to step 317.

In step 317, processor 110 generates Merchant-level purchase penetration list 226, Merchant-level card penetration list 227, and Merchant-level transaction penetration list 228.

Merchant-level purchase penetration list 226 shows, for each merchant listed in Consolidated merchant list 218, a ratio of (i) total spending at the merchant by customers of Merchant-X, to (b) total spending at all of the merchants by customers of Merchant-X.

Table 11 is an example of Merchant-level purchase penetration list 226.

TABLE 11
Merchant-level purchase penetration list 226

| | Account- | Account- | Account- | Total | Purchase |
|---|---|---|---|---|---|
| Merchant | 1 | 2 | N | ($) | Penetration |
| Merchant-X | 30 | 40 | 30 | 100 | 28.2% |
| Merchant-1 | 10 | 0 | 60 | 70 | 19.7% |
| Merchant-2 | 20 | 15 | 0 | 35 | 9.9% |
| Merchant-3 | 30 | 25 | 40 | 95 | 26.8% |
| Merchant-4 | 0 | 35 | 0 | 35 | 9.9% |
| Merchant-5 | 0 | 0 | 20 | 20 | 5.6% |
| Total | 90 | 115 | 150 | 355 | ≈100% |

Total spending at all of the merchants by customers of Merchant-X is $355, and total spending at Merchant-X by customers of Merchant-X is $100. Accordingly, Table 11 shows that for Merchant-X, the ratio of (i) total spending at Merchant-X by customers of Merchant-X, to (ii) total spending at all of the merchants by customers of Merchant-X is:

Merchant-X merchant-level purchase penetration=100/355=28.2%

Similarly, for Merchant-1, the ratio of (i) total spending at Merchant-1 by customers of Merchant-X, to (ii) total spending at all of the merchants by customers of Merchant-X is:

Merchant-1 merchant-level purchase penetration=70/355=19.7%

Thus, total spending at all of the merchants by customers of Merchant-X is $355, where:
(a) 28.2% of $355 (i.e., $100) is spent at Merchant-X;
(b) 19.7% of $355 (i.e., $70) is spent at Merchant-1;
(c) 9.9% of $355 (i.e., $35) is spent at Merchant-2;
(d) 26.8% of $355 (i.e., $95) is spent at Mechant-3;
(e) 9.9% of $355 (i.e., $35) is spent at Merchant-4; and
(f) 5.6% of $355 (i.e., $20) is spent at Merchant-5.

From Table 11, it is apparent that Merchant-X's customers spent the greatest percentage, i.e., 28.2%, at Merchant-X, and the next greatest percentage, i.e., 26.8%, at Merchant-3.

Merchant-level card penetration list 227 shows, for each merchant listed in Consolidated merchant list 218, a ratio of (i) total number of active cards, i.e., accounts, that engaged in transactions with Merchant-X and also with the merchant, to (ii) a total number of active cards that engaged in transactions with Merchant-X.

Table 12 is an example of Merchant-level card penetration list 227.

TABLE 12
Merchant-level card penetration list 227

| | | | | Number | Card |
|---|---|---|---|---|---|
| | Account- | Account- | Account- | of active | Pene- |
| Merchant | 1 | 2 | N | cards | tration |
| Merchant-X | 30 | 40 | 30 | 3 | 100.0% |
| Merchant-1 | 10 | 0 | 60 | 2 | 66.7% |
| Merchant-2 | 20 | 15 | 0 | 2 | 66.7% |
| Merchant-3 | 30 | 25 | 40 | 3 | 100.0% |
| Merchant-4 | 0 | 35 | 0 | 1 | 33.3% |
| Merchant-5 | 0 | 0 | 20 | 1 | 33.3% |

In the present example, there are three active cards that engaged in transactions with Merchant-X, namely, Account-1, Account-2 and Account-N. Table 12 shows, for example, for Merchant-1, the ratio of (i) total number of active cards that engaged in transactions with Merchant-X and also with Merchant-1, to (ii) total number of active cards that engaged in transactions with Merchant-X is:

Merchant-1 merchant-level card penetration=2/3=66.7%

This means that 66.7% of Merchant-X's customers also engaged in transactions with Merchant-1.

Note that for Merchant-X, the ratio of (i) total number of active cards that engaged in transactions with Merchant-X and also with Merchant-X, to (ii) total number of active cards that engaged in transactions with Merchant-X is:

Merchant-X merchant-level card penetration=3/3=100.0%

This is to be expected because, by definition, 100.0% of Merchant-X's customers engaged in transactions with Merchant-X.

Merchant-level transaction penetration list 228 shows, for each merchant listed in Consolidated merchant list 218, a ratio of (i) total number of transactions at the merchant by customers of Merchant-X, to (b) total number of transactions at all of the merchants by customers of Merchant-X.

Table 13 is an example of Merchant-level transaction penetration list 228.

TABLE 13
Merchant-level transaction penetration list 228

| | | | | Total | Transaction |
|---|---|---|---|---|---|
| | Account- | Account- | Account- | trans- | pene- |
| Merchant | 1 | 2 | N | actions | tration |
| Merchant-X | 1 | 2 | 3 | 6 | 25.0% |
| Merchant-1 | 1 | 0 | 1 | 2 | 8.3% |
| Merchant-2 | 2 | 3 | 0 | 5 | 20.8% |
| Merchant-3 | 4 | 3 | 2 | 9 | 37.5% |
| Merchant-4 | 0 | 1 | 0 | 1 | 4.2% |
| Merchant-5 | 0 | 0 | 1 | 1 | 4.2% |
| Total | 8 | 9 | 7 | 24 | 100% |

Table 13 shows, for example, that for Merchant-X, the ratio of (i) total number of transactions at the merchant by customers of Merchant-X, to (b) total number of transactions at all of the merchants by customers of Merchant-X is:

Merchant-X's merchant-level transaction penetration=6/24=25.0%

Thus, the total number of transactions by Merchant-X's customers is 24, where:
(a) 25.0% (i.e., 6) of the transactions are with Merchant-X;
(b) 8.3% (i.e., 2) of the transactions are with Merchant-1;
(c) 20.8% (i.e., 5) of the transactions are with Merchant-2;
(d) 37.5% (i.e., 9) of the transactions are with Merchant-3;
(e) 4.2% (i.e., 1) of the transactions is with Merchant-4; and
(f) 4.2% (i.e., 1) of the transactions is with Merchant-5.

From step 317, process 120 progresses to step 320.

So far, in step 302-step 317, process 120 has considered transactions at the merchant-level, that is, for Merchant-X, Merchant-1, Merchant-2, Merchant-3, Merchant-4 and Merchant-5. In step 320-step 335, process 120 will consider transactions at a regional, e.g., national, level to provide a baseline for comparison against national metrics.

National-level metrics differ from merchant-level metrics by the population. Merchant-level metrics denote the behavior of Merchant-X's customers. National-level metrics denote the behavior of a national population of customers.

Process 120 defines the national population to reflect the merchant shopping population in terms of credit and/or debit card users, consumer and/or corporate card users, and the combination of the above. For example, airlines and rental car companies will typically have a much higher corporate credit card usage than movie tickets buyers (mostly consumer credit/debit cards). A refined baseline national selection will yield a more robust index that matches the appropriate merchant population.

In step 320, processor 110 generates National card number list 230.

National card number list 230 is a list of spend-active account numbers in filtered transactions 205 that have engaged in transactions with any merchant listed in Consolidated merchant list 218.

A spend-active account is an account that, during the specified period of time, engaged in at least some minimum number of transactions, e.g., at least 12 transactions, and spent at least some minimum amount, e.g., at least $500. The reason for identifying spend-active accounts is to preclude consideration of secondary or marginally active cards, e.g., a card that a person rarely uses.

Table 14 is an example of National card number list 230.

TABLE 14
National card number list 230
Account Number

Account-1
Account-2
Account-N
Account-X
Account-Y

Note that since National card number list 230 lists account numbers that engaged in transactions with any merchant listed in Consolidated merchant list 218, National card number list 230 will likely include not only account numbers that engaged in transactions with Merchant-X, but also account numbers that did not engage in any transaction with Merchant-X. Thus, in the present example, National card number list 230 includes not only Account-1, Account-2 and Account-N, but also Account-X and Account-Y, where Account-X and Account-Y did not engage in any transaction with Merchant-X.

From step 320, process 120 progresses to step 325.

In step 325, processor 110 accesses filtered transactions 205 and generates, for each account listed in National card number list 230, a list of merchants from which the account made at least some threshold number of purchases, e.g., greater than or equal to one purchase, during the specified period of time, i.e., Jan. 1, 2013 through Dec. 31, 2013. In the present example, processor 110 would generate a list of merchants for each of Account-1, Account-2, Account-N, Account-X and Account-Y. However, whereas in step 310 processor 110 already generated Account-1 merchant list 215-1, Account-2 merchant list 215-2, and Account-N merchant list 215-N, in step 325, processor 110 need only generate Account-X merchant list 235-X and Account-Y merchant list 235-Y.

Each of Account-X merchant list 235-X and Account-Y merchant list 235-Y includes a number of transactions at each merchant, and an aggregate amount of the purchases at each merchant.

Table 15 is an example of Account-X merchant list 235-X.

TABLE 15
Account-X merchant list 235-X

| Merchant | Number of transactions | Amount ($) |
|---|---|---|
| Merchant-1 | 3 | 23 |
| Merchant-3 | 5 | 100 |
| Merchant-4 | 7 | 350 |

Account-X merchant list 235-X, as exemplified in Table 15, shows that Account-X, during the period of time from Jan. 1, 2013 through Dec. 31, 2013, spent $23 with Merchant-1, $100 with Merchant-3, and $350 with Merchant-4.

Table 16 is an example of Account-Y merchant list 235-Y.

TABLE 16
Account-Y merchant list 235-Y

| Merchant | Number of transactions | Amount ($) |
|---|---|---|
| Merchant-1 | 2 | 34 |
| Merchant-2 | 2 | 88 |
| Merchant-3 | 4 | 213 |
| Merchant-5 | 4 | 76 |

Account-Y merchant list 235-Y, as exemplified in Table 16, shows that Account-Y, during the period of time from Jan. 1, 2013 through Dec. 31, 2013, spent $34 with Merchant-1, $88 with Merchant-2, $213 with Merchant-3, and $76 with Merchant-5.

From step 325, process 120 progresses to step 330.

In step 330, processor 110 generates National-level aggregate purchases list 240 and National-level aggregate number of transactions list 245.

National-level aggregate purchases list 240 lists, for each merchant in Consolidated merchant list 218, the aggregate value of the transactions between the merchant and each customer, and the aggregate value of the transactions from all customers, during the specified period of time.

Table 17 is an example of National-level aggregate purchases list 240.

TABLE 17
National-level aggregate purchases list 240

| | Ac- | Ac- | Ac- | Ac- | Ac- | Total |
|---|---|---|---|---|---|---|
| Merchant | count-1 | count-2 | count-N | count X | count Y | ($) |
| Merchant-X | 30 | 40 | 30 | 0 | 0 | 100 |
| Merchant-1 | 10 | 0 | 60 | 23 | 34 | 127 |
| Merchant-2 | 20 | 15 | 0 | 0 | 88 | 123 |
| Merchant-3 | 30 | 25 | 40 | 100 | 213 | 408 |
| Merchant-4 | 0 | 35 | 0 | 350 | 0 | 385 |
| Merchant-5 | 0 | 0 | 20 | 0 | 76 | 96 |
| Total | 90 | 115 | 150 | 473 | 411 | 1239 |

Table 17 shows, for example, that during the period of time from Jan. 1, 2013 through Dec. 31, 2013, (a) Account-1, Account-N, Account-X and Account-Y, in aggregate, spent $127 with Merchant-1, and that Account-X spent $473, in aggregate, with all merchants.

Table 18 is an example of National-level aggregate number of transactions list 245.

TABLE 18
National-level aggregate number of transactions list 245

| | Ac- | Ac- | Ac- | Ac- | Ac- | Total |
|---|---|---|---|---|---|---|
| Merchant | count-1 | count-2 | count-N | count X | count Y | Trans |
| Merchant-X | 1 | 2 | 3 | 0 | 0 | 6 |
| Merchant-1 | 1 | 0 | 1 | 3 | 2 | 7 |
| Merchant-2 | 2 | 3 | 0 | 0 | 2 | 7 |
| Merchant-3 | 4 | 3 | 2 | 5 | 4 | 18 |
| Merchant-4 | 0 | 1 | 0 | 7 | 0 | 8 |
| Merchant-5 | 0 | 0 | 1 | 0 | 4 | 5 |
| Total | 8 | 9 | 7 | 15 | 12 | 51 |

Table 18 shows, for example, that during the period of time from Jan. 1, 2013 through Dec. 31, 2013, (a) Account-1, Account-N, Account-X, and Account-Y, in aggregate, engaged in 7 transactions with Merchant-1, and (b) Account-X engaged in 15 transactions, in aggregate, with all of the merchants.

From step 330, process 120 progresses to step 335.

In step 335, processor 110 generates National-level purchase penetration list 246, National-level card penetration list 247, and National-level transaction penetration list 248.

National-level purchase penetration list 246 shows, for each merchant listed in Consolidated merchant list 218, a ratio of (i) total spending at the merchant by customers of any of the merchants, to (b) total spending at all of the merchants by customers of any of the merchants.

Table 19 is an example of National-level purchase penetration list 246.

TABLE 19
National-level purchase penetration list 246

| | Acct- | Acct- | Acct- | Acct- | Acct- | Total | Purchase |
|---|---|---|---|---|---|---|---|
| Merchant | 1 | 2 | N | X | Y | ($) | Penetration |
| Merchant-X | 30 | 40 | 30 | 0 | 0 | 100 | 8.1% |
| Merchant-1 | 10 | 0 | 60 | 23 | 34 | 127 | 10.3% |
| Merchant-2 | 20 | 15 | 0 | 0 | 88 | 123 | 9.9% |
| Merchant-3 | 30 | 25 | 40 | 100 | 213 | 408 | 32.9% |
| Merchant-4 | 0 | 35 | 0 | 350 | 0 | 385 | 31.1% |
| Merchant-5 | 0 | 0 | 20 | 0 | 76 | 96 | 7.7% |
| Total | | | | | | 1239 | 100% |

Note:
In Table 19, “Account” is abbreviated as “Acct”.

Table 19 shows, for example, that for Merchant-X, the ratio of (i) total spending at Merchant-X by customers of any of the merchants, to (b) total spending at all of the merchants by customers of any of the merchants is:

Merchant-X national-level purchase penetration=100/1239=8.1%

This means that the national population spends 8.1% of its total with Merchant-X.

National-level card penetration list 247 shows, for each merchant listed in Consolidated merchant list 218, a ratio of (i) total number of active cards, i.e., accounts, that engaged in transactions with the merchant, to (ii) a total number of active cards that engaged in transactions with any of the merchants.

Table 20 is an example of National-level card penetration list 247.

TABLE 20
National-level card penetration list 247

| | | | | | | # of | |
|---|---|---|---|---|---|---|---|
| | Acct- | Acct- | Acct- | Acct- | Acct- | active | Card |
| Merchant | 1 | 2 | N | X | Y | Cards | Penetration |
| Merchant-X | 30 | 40 | 30 | 0 | 0 | 3 | 60.0% |
| Merchant-1 | 10 | 0 | 60 | 23 | 34 | 4 | 80.0% |
| Merchant-2 | 20 | 15 | 0 | 0 | 88 | 3 | 60.0% |
| Merchant-3 | 30 | 25 | 40 | 100 | 213 | 5 | 100.0% |
| Merchant-4 | 0 | 35 | 0 | 350 | 0 | 2 | 40.0% |
| Merchant-5 | 0 | 0 | 20 | 0 | 76 | 2 | 40.0% |

Note:
In Table 20, “Account” is abbreviated as “Acct”.

In the present example, there are five active cards that engaged in transactions with any merchant, namely, Account-1, Account-2, Account-N, Account-X and Account-Y. Table 20 shows, for example, that for Merchant-X, the ratio of (i) total number of active cards that engaged in transactions with Merchant-X, to (ii) total number of active cards that engaged in transactions with any of the merchants is:

Merchant-X national-level card penetration=3/5=60.0%

Thus, 60.0% of national customers were customers of Merchant-X.

National-level transaction penetration list 248 shows, for each merchant listed in Consolidated merchant list 218, a ratio of (i) total number of transactions with the merchant, to (ii) a total number of transactions with any of the merchants.

Table 21 is an example of National-level transaction penetration list 248.

TABLE 21
National-level transaction penetration list 248

| | Acct- | Acct- | Acct- | Acct- | Acct- | Total | Trans |
|---|---|---|---|---|---|---|---|
| Merchant | 1 | 2 | N | X | Y | trans | penetration |
| Merchant-X | 1 | 2 | 3 | 0 | 0 | 6 | 11.8% |
| Merchant-1 | 1 | 0 | 1 | 3 | 2 | 7 | 13.7% |
| Merchant-2 | 2 | 3 | 0 | 0 | 2 | 7 | 13.7% |
| Merchant-3 | 4 | 3 | 2 | 5 | 4 | 18 | 35.3% |
| Merchant-4 | 0 | 1 | 0 | 7 | 0 | 8 | 15.7% |
| Merchant-5 | 0 | 0 | 1 | 0 | 4 | 5 | 9.8% |
| Total | 8 | 9 | 7 | 15 | 12 | 51 | 100% |

Note:
In Table 21, “Account” is abbreviated as “Acct”, and “Transaction” is abbreviated as “Trans”.

Table 21 shows, for example, that for Merchant-X, the ratio of (i) total number of transactions with Merchant-X, to (ii) a total number of transactions with any merchant is:

Merchant-X national-level transaction penetration=6/51=11.8%

Thus, 11.8% of national transactions were at Merchant-X.

From step 335, process 120 progresses to step 340.

In step 340, processor 110 compares penetrations against each other to generate various indexes, which are presented in Spend index list 250, Card index list 255 and Transaction index list 260. These indexes show how Merchant X's customers behave as compared to national overall customers. Affinity metrics will be a comparison not only of Merchant-X's behavior, but also Merchant-X's behavior as compared to a national affinity.

Spend index list 250 shows, for each merchant listed in Consolidated merchant list 218, a spend index that is a ratio of (a) the merchant's merchant-level purchase penetration, to (ii) the merchant's national-level purchase penetration.

The spend index is an indicator of how Merchant X's customers behave as compared to national overall customers, based on the amounts spent by the customers.

Table 22 is an example of Spend index list 250.

TABLE 22
Spend index list 250

| | Merchant-level | National-level | |
|---|---|---|---|
| | purchase | purchase | |
| Merchant | penetration | penetration | Spend index |
| Merchant-X | 28.2% | 8.1% | 3.48 |
| Merchant-1 | 19.7% | 10.3% | 1.91 |
| Merchant-2 | 9.9% | 9.9% | 1.00 |
| Merchant-3 | 26.8% | 32.9% | 0.81 |
| Merchant-4 | 9.9% | 31.1% | 0.32 |
| Merchant-5 | 5.6% | 7.7% | 0.73 |

Table 22 shows, for example, that for Merchant-X, the ratio of (a) Merchant-X's merchant-level purchase penetration (see Table 11), to (ii) Merchant-X's national-level purchase penetration (see Table 19) is:

Merchant-X's spend index=28.2/8.1=3.48

Merchant-X's spend index=3.48 indicates that Merchant-X's customers are 3.48 times more likely than an average national customer to spend at Merchant-X.

Table 22 also shows that for Merchant-1, the ratio of (a) Merchant-1's merchant-level purchase penetration (see Table 11), to (ii) Merchant-1's national-level purchase penetration (see Table 19) is:

Merchant-1's spend index=19.7/10.3=1.91

Merchant-1's spend index=1.91 shows that Merchant-X's customers are 1.91 times more likely than an average national customer to spend at Merchant-1. Thus, there is a high spend affinity between Merchant-X and Merchant-1. Decisions involving advertising and product strategies can be derived from this information.

Table 22 also shows that for Merchant-4, the ratio of (a) Merchant-4's merchant-level purchase penetration (see Table 11), to (ii) Merchant-4's national-level purchase penetration (see Table 19) is:

Merchant-4's spend index=9.9/31.1=0.32

Merchant-4's spend index=0.32 shows that Merchant-X's customers are 0.32 times as likely, and therefore 68% less likely, than an average national customer to spend at Merchant-4. Thus, there is a low spend affinity between Merchant-X and Merchant-4. For example, if there is an existing advertising arrangement or partnership between Merchant-X and Merchant-4, the arrangement or partnership should be revisited.

Card index list 255 shows, for each merchant listed in Consolidated merchant list 218, a card index that is a ratio of (i) the merchant's merchant-level card penetration, to (ii) the merchant's national-level card penetration.

The card index is an indicator of how Merchant X's customers behave as compared to national overall customers, based on card penetration.

Table 23 is an example of Card index list 255.

TABLE 23
Card index list 255

| | Merchant-level | National-level | |
|---|---|---|---|
| Merchant | card penetration | card penetration | Card Index |
| Merchant-X | 100.0% | 60.0% | 1.67 |
| Merchant-1 | 66.7% | 80.0% | 0.83 |
| Merchant-2 | 66.7% | 60.0% | 1.11 |
| Merchant-3 | 100.0% | 100.0% | 1.00 |
| Merchant-4 | 33.3% | 40.0% | 0.83 |
| Merchant-5 | 33.3% | 40.0% | 0.83 |

Table 23 shows, for example, that for Merchant-X, the ratio of (i) Merchant-X's merchant-level card penetration (see Table 12), to (ii) Merchant-X's national-level card penetration (see Table 20) is:

Merchant-X's card index=100.0/60.0=1.67

Merchant-X's card index=1.67 shows that Merchant-X's customers shop at Merchant-X about 67% more than an average national customer.

Table 23 also shows that Merchant-1's card index is 0.83. This indicates that Merchant-X's customers shop at Merchant-1 about 17% less than an average national customer.

Table 23 also shows that Merchant-2's card index is 1.11. This indicates that Merchant-X's customers shop at Merchant-2 about 11% more than the average national customer.

Transaction index list 260 shows, for each merchant listed in Consolidated merchant list 218, a transaction index that is a ratio of (i) the merchant's merchant level transaction penetration, to (ii) the merchant's national-level transaction penetration.

A transaction index denotes the frequency of visit at a merchant. It can be useful in determining foot traffic to the type of industry. For example, for a coffee drinker, there may be at least one transaction per day at a coffee shop as opposed to a rare transaction at furniture store.

Table 24 is an example of Transaction index list 260.

TABLE 24
Transaction index list 260

| | Merchant-level | National-level | |
|---|---|---|---|
| | transaction | transaction | |
| Merchant | penetration | penetration | Transaction index |
| Merchant-x | 25.0% | 11.8% | 2.12 |
| Merchant-1 | 8.3% | 13.7% | 0.61 |
| Merchant-2 | 20.8% | 13.7% | 1.52 |
| Merchant-3 | 37.5% | 35.3% | 1.06 |
| Merchant-4 | 4.2% | 15.7% | 0.27 |
| Merchant-5 | 4.2% | 9.8% | 0.43 |

Table 23 shows, for example, that for Merchant-X, the ratio of (i) Merchant-X's merchant level transaction penetration (see Table 13), to (ii) Merchant-X's national-level transaction penetration (see Table 21) is:

Merchant-X's transaction index=25.0/11.8=2.12

Thus, Merchant-X customers transacted 2.12 times more at Merchant-X than the national average customers transacted at Merchant-X.

From step 340, process 120 progresses to step 345.

In step 345, processor 110 utilizes one or more of the indexes in Spend index list 250, Card index list 255 or Transaction index list 260 as a trigger to send a correspondence to one or more recipients.

Table 25 is a summary of the indexes in Spend index list 250, Card index list 255 and Transaction index list 260, from Table 22, Table 23 and Table 24, respectively.

TABLE 25
Summary of indexes

| Merchant | Spend index | Card index | Transaction index |
|---|---|---|---|
| Merchant-X | 3.48 | 1.67 | 2.12 |
| Merchant-1 | 1.91 | 0.83 | 0.61 |
| Merchant-2 | 1.00 | 1.11 | 1.52 |
| Merchant-3 | 0.81 | 1.00 | 1.06 |
| Merchant-4 | 0.32 | 0.83 | 0.27 |
| Merchant-5 | 0.73 | 0.83 | 0.43 |

Table 25 shows that for Merchant-2, all of the spend index, the card index and the transaction index are greater than or equal to 1.00, and for Merchant-4, all of the indices are less than 1.00. Accordingly, processor 110 recognizes that Merchant-X has (a) a relatively high affinity with Merchant-2, and in particular, with respect to card penetration and transactions, and (b) a relatively low affinity with Merchant-4.

Assume that user 140 is an employee of Merchant-X. Since processor 110 recognizes that Merchant-X has a relatively high affinity with Merchant-2, processor 110 will send a communication, e.g., an email, to user 140, via user device 150, with a recommendation that Merchant-X explore further relations with Merchant-2. Similarly, processor 110 will send a communication to user 140 with a recommendation that Merchant-X break off, or at least reconsider, any relationship Merchant-X may have with Merchant-4. As an alternative to the two aforementioned communications, processor 110 can send to user 140 a consolidated report that recites both of the recommendations.

Assume that user 142 is an employee of Merchant-2. Similarly to sending a communication with a recommendation to Merchant-X to explore further relations with Merchant-2, processor 110 can send a communication to user 142, with a recommendation that Merchant-1 explore a possible relationship with Merchant-X.

Assume that user 144 is a customer of Merchant-X, and more particularly the holder of the card for Account-1. Since processor 110 recognizes that Merchant-X has a relatively high affinity with Merchant-2, processor 110 can send to user 144 a communication that includes an advertisement concerning Merchant-2, or an offer, e.g., discount, for a product or service that user 142 can obtain from Merchant-2.

System 100, through employment of process 120, analyzes data that is stored in database 125, and as a result of the analysis, automatically issues pertinent communications to parties that could benefit from the analysis. Such communications can (a) facilitate introductions between parties, e.g., introducing Merchant-X to Merchant-2, that might otherwise not take place, or (b) encourage an additional transaction, e.g., between a customer and a merchant.

In summary, system 100, and more specifically, processor 110, performs process 120, which includes:
(a) accessing database 125, which contains transactions 126, i.e., records of payment card transactions;
(b) filtering the records based on a filtering criterion and a period of time, thus yielding filtered transactions 205 that occurred during the period of time;
(c) identifying from filtered transactions 205, customers of Merchant-X;
(d) identifying from filtered transactions 205, another merchant with which the customers engaged in transactions; and
(e) calculating, from filtered transactions 205, an index that shows an affinity between the Merchant-X and the other merchant.

The customers of Merchant-X (e.g., Account-1, Account-2 and Account-N) are regarded as a first population of customers. The calculating of the index includes quantifying a behavior (e.g., spending, number of transactions, number of accounts) of the first population of customers, with respect to a behavior (e.g., spending, number of transactions, number of accounts) of a second population of customers (e.g., Account-1, Account-2, Account-N, Account-X and Account-Y) that includes the first population of customers and additional customers.

The terms “comprises” or “comprising” are to be interpreted as specifying the presence of the stated features, integers, steps or components, but not precluding the presence of one or more other features, integers, steps or components or groups thereof. The terms “a” and “an” are indefinite articles, and as such, do not preclude embodiments having pluralities of articles.

The techniques described herein are exemplary, and should not be construed as implying any particular limitation on the present disclosure. It should be understood that various alternatives, combinations and modifications could be devised by those skilled in the art. For example, steps associated with the processes described herein can be performed in any order, unless otherwise specified or dictated by the steps themselves. The present disclosure is intended to embrace all such alternatives, modifications and variances that fall within the scope of the appended claims.

What is claimed is:

1. A method comprising:
accessing a database that contains records of payment card transactions;
filtering said records based on a filtering criterion and a period of time, thus yielding filtered transactions that occurred during said period of time;
identifying from said filtered transactions, customers of a first merchant;
identifying from said filtered transactions, a second merchant with which said customers engaged in transactions; and
calculating, from said filtered transactions, an index that shows an affinity between said first merchant and said second merchant.

2. The method of claim 1,
wherein said customers of said first merchant are regarded as a first population of customers,
wherein said calculating includes quantifying a behavior of said first population of customers, with respect to a behavior of a second population of customers, and
wherein said second population of customers includes said first population of customers and additional customers.

3. The method of claim 1, wherein said calculating includes an operation selected from the group consisting of:
(a) calculating a total value of transactions between said customers and said first merchant;
(b) calculating a total number of said customers; and
(c) calculating a total number of transactions between said customers and said first merchant.

4. The method of claim 1, further comprising sending a communication to at least one of said first merchant and said second merchant, based on said index.

5. The method of claim 1,
wherein said customers of said first merchant include a subject customer, and
wherein said method further comprises sending a communication to said subject customer, based on said index.

6. A system comprising:
a processor; and
a memory that contains instructions that are readable by said processor, and that control said processor to perform operations of:
accessing a database that contains records of payment card transactions;
filtering said records based on a filtering criterion and a period of time, thus yielding filtered transactions that occurred during said period of time;
identifying from said filtered transactions, customers of a first merchant;
identifying from said filtered transactions, a second merchant with which said customers engaged in transactions; and
calculating, from said filtered transactions, an index that shows an affinity between said first merchant and said second merchant.

7. The system of claim 6,
wherein said customers of said first merchant are regarded as a first population of customers,
wherein said calculating includes quantifying a behavior of said first population of customers, with respect to a behavior of a second population of customers, and
wherein said second population of customers includes said first population of customers and additional customers.

8. The system of claim 6, wherein said calculating includes an operation selected from the group consisting of:
(a) calculating a total value of transactions between said customers and said first merchant;
(b) calculating a total number of said customers; and
(c) calculating a total number of transactions between said customers and said first merchant.

9. The system of claim 6, wherein said instructions further control said processor to perform an operation of sending a communication to at least one of said first merchant and said second merchant, based on said index.

10. The system of claim 6,
wherein said customers of said first merchant include a subject customer, and
wherein said instructions further control said processor to perform an operation of sending a communication to said subject customer, based on said index.

11. A storage device comprising
instructions that are readable by a processor, and that control said processor to perform operations of:
accessing a database that contains records of payment card transactions;
filtering said records based on a filtering criterion and a period of time, thus yielding filtered transactions that occurred during said period of time;
identifying from said filtered transactions, customers of a first merchant;
identifying from said filtered transactions, a second merchant with which said customers engaged in transactions; and
calculating, from said filtered transactions, an index that shows an affinity between said first merchant and said second merchant.

12. The storage device of claim 11,
wherein said customers of said first merchant are regarded as a first population of customers,
wherein said calculating includes quantifying a behavior of said first population of customers, with respect to a behavior of a second population of customers, and
wherein said second population of customers includes said first population of customers and additional customers.

13. The storage device of claim 11, wherein said calculating includes an operation selected from the group consisting of:
(a) calculating a total value of transactions between said customers and said first merchant;
(b) calculating a total number of said customers; and
(c) calculating a total number of transactions between said customers and said first merchant.

14. The storage device of claim 11, wherein said instructions further control said processor to perform an operation of sending a communication to at least one of said first merchant and said second merchant, based on said index.

15. The storage device of claim 11,
wherein said customers of said first merchant include a subject customer, and
wherein said instructions further control said processor to perform an operation of sending a communication to said subject customer, based on said index.
